(19) United States
(12) Patent Application Publication
(10) Pub. No.: US 2020/0218084 A1
(43) Pub. Date: Jul. 9, 2020

(54) STEREOSCOPIC DISPLAY DEVICE, METHOD AND APPARATUS FOR CONTROLLING STEREOSCOPIC DISPLAY DEVICE, AND STORAGE MEDIUM

(71) Applicant: BOE Technology Group Co., Ltd., Beijing (CN)

(72) Inventors: Jinye Zhu, Beijing (CN); Jiayao Liu, Beijing (CN); Wenqing Zhao, Beijing (CN)

(21) Appl. No.: 16/624,425

(22) PCT Filed: Nov. 19, 2018
(86) PCT No.: PCT/CN2018/116236

§ 371 Date: Dec. 19, 2019

(30) Foreign Application Priority Data
Mar. 30, 2018 (CN) 201810292314.1

(51) Int. Cl. G02B 30/22; G02B 3/14; G02B 26/00

(52) U.S. Cl. CPC G02B 30/22; G02B 26/005; G02B 3/14

(57) ABSTRACT

A stereoscopic display device, a method and apparatus for controlling the stereoscopic display device and a storage medium are provided. The stereoscopic display device includes a display panel and a varifocal lens array. The varifocal lens array is on a side of display panel where an image surface is; the varifocal lens array comprises at least two varifocal lenses arranged in an array, wherein any one of the varifocal lenses corresponds to at least one sub-pixel region on the display panel, and the at least two varifocal lenses are configured such that colored lights of the corresponding sub-pixel regions form images having different image distances on a side of the varifocal lenses near the display panel; wherein the image surface of the display panel is a surface of the display panel where colored light is formed. The effects of higher resolution and brightness of the stereoscopic display device are achieved.

### CROSS-REFERENCE TO RELATED APPLICATION

This application is a 371 of PCT Patent Application No. PCT/CN2018/116236 filed on Nov. 19, 2018, which claims priority to Chinese Patent Application No. 201810292314.1 filed on Mar. 30, 2018 and entitled “STEREOSCOPIC DISPLAY DEVICE AND CONTROL METHOD FOR STEREOSCOPIC DISPLAY DEVICE”, the entire contents of which are incorporated herein by reference.

### TECHNICAL FIELD

The present application relates to a stereoscopic display device, a method and apparatus for controlling the stereoscopic display device, and a storage medium.

### BACKGROUND

A stereoscopic display device is a device having a stereoscopic display function. A parallax type stereoscopic display device based on the principle of parallax is common at present.

A parallax type stereoscopic display device in the related art includes a display panel and a parallax barrier disposed on a light exiting side of the display panel, wherein the parallax barrier is provided with a plurality of bright stripes and dark stripes which are spaced apart. The bright stripes are stripes which can be penetrable by light, while the dark stripes are stripes that are impenetrable by light. By blocking with these dark stripes, a viewer viewing the display panel will see different images through the left eye and the right eye, respectively. The human eyes may adjust and assemble the different images, thereby giving the viewer a stereoscopic impression.

### SUMMARY

The embodiments of the present application provides a stereoscopic display device, a method and apparatus for controlling the stereoscopic display device, and a storage medium. According to a first aspect of the present application, a stereoscopic display device is provided. The stereoscopic display device includes a display panel and a varifocal lens array; wherein

the varifocal lens array is disposed on a side of display panel where an image surface is;

the varifocal lens array includes at least two varifocal lenses arranged in an array, wherein any one of the varifocal lenses corresponds to at least one sub-pixel region on the display panel, and the at least two varifocal lenses are configured to be capable of making colored lights of the corresponding sub-pixel regions form images having different image distances on a side of the varifocal lenses near the display panel; wherein

the image surface of the display panel is a surface of the display panel where colored light is formed.

Optionally, each varifocal lens corresponds to one sub-pixel region on the display panel.

Optionally, an orthographic projection of a sub-pixel region corresponding to any one of the at least two varifocal lenses on a lens plane is located in a region where said any one of the at least two varifocal lenses is on the lens plane, and the lens plane is a plane where the varifocal lens array is.

Optionally, the lens plane is parallel to the image surface of the display panel, and

the display panel includes a plurality of pixel regions, and each of the pixel regions includes at least one of the sub-pixel regions.

Optionally, the display panel is a liquid crystal display panel comprising a color filter substrate, wherein

a surface of the color filter substrate near the varifocal lens array is the image surface.

Optionally, the display panel is an organic light-emitting diode display panel comprising a light-emitting layer, wherein

a surface of the light-emitting layer near the varifocal lens array is the image surface.

Optionally, each of the varifocal lenses is an electrostrictive lens.

Optionally, the electrostrictive lens includes a transparent electrostrictive ceramic lens and an electric field component disposed outside the transparent electrostrictive ceramic lens.

Optionally, each of the varifocal lenses is a liquid varifocal lens.

Optionally, the liquid varifocal lens is a liquid varifocal lens based on electrowetting principle.

Optionally, each of the varifocal lenses is a liquid crystal varifocal lens.

Optionally, the liquid crystal varifocal lens includes a liquid crystal lens and an electric field component disposed outside the liquid crystal lens.

Optionally, the electric field component includes a circular electrode and at least one annular electrode disposed around the circular electrode.

Optionally, the electric field component includes:

an electrode layer disposed on one surface of the transparent electrostrictive ceramic lens, and an electrode pattern disposed on the other surface of the transparent electrostrictive ceramic lens, wherein the electrode pattern includes a circular electrode and at least one annular electrode disposed around the circular electrode.

Optionally, the electric field component includes:

electrode patterns disposed on both sides of the transparent electrostrictive ceramic lens, wherein each of the electrode patterns includes a circular electrode and at least one annular electrode disposed around the circular electrode.

Optionally, each of the varifocal lenses is a spherical varifocal lens or an aspherical varifocal lens.

According to a second aspect of embodiments of the present application, a method for controlling a stereoscopic display device is provided, and the method is used to control the stereoscopic display device according to the first aspect. The method includes:

acquiring display control instructions, the display control instructions comprising a first instruction for controlling a display panel in the stereoscopic display device and a second instruction for controlling a varifocal lens array in the stereoscopic display device;

controlling the display panel to display according to the first instruction; and

setting focal lengths of varifocal lenses in the varifocal lens array according to the second instruction to form a virtual image of a picture displayed by the display panel on a side of the varifocal lens array near the display panel.

Optionally, setting focal lengths of varifocal lenses in the varifocal lens array according to the second instruction to form a virtual image of a picture displayed by the display panel on a side of the varifocal lens array near the display panel includes:

controlling, according to the second instruction, focal lengths of different varifocal lenses in the varifocal lens array, such that the display panel forms virtual images having different image distances on a side of the varifocal lens array near the display panel.

According to a third aspect of embodiments of the present application, a apparatus for controlling a stereoscopic display device is provided, and the device is used to control the stereoscopic display device according to the first aspect. The apparatus for controlling a stereoscopic display device includes:

one or more processor; and

a memory; wherein

one or more programs are stored in the memory, the one or more programs are configured to be executed by the one or more processors, and the one or more programs include instructions for performing the following operations:

acquiring display control instructions, the display control instructions comprising a first instruction for controlling a display panel in the stereoscopic display device and a second instruction for controlling a varifocal lens array in the stereoscopic display device;

controlling the display panel to display according to the first instruction; and

setting focal lengths of varifocal lenses in the varifocal lens array according to the second instruction to form a virtual image of a picture displayed by the display panel on a side of the varifocal lens array near the display panel.

Optionally, the one or more programs further comprise instructions for implementing:

controlling, according to the second instruction, focal lengths of different varifocal lenses in the varifocal lens array, such that the display panel forms virtual images having different image distances on a side of the varifocal lens array near the display panel.

According to a fourth aspect of embodiments of the present application, a computer readable storage medium is provided. Computer programs are stored in the storage medium. The computer programs implement the method for controlling the stereoscopic display device according to the second aspect when executed by the processor.

### BRIEF DESCRIPTION OF THE DRAWINGS

FIG. 1 is a schematic structural diagram of a stereoscopic display device shown in an embodiment of the present application;

FIG. 2 is a schematic structural diagram of another stereoscopic display device shown in an embodiment of the present application;

FIG. 3 is a schematic diagram of a stereoscopic display device observed by human eyes from one side of a varifocal lens array away from a display panel;

FIG. 4 is a schematic structural diagram of yet another stereoscopic display device shown in an embodiment of the present application;

FIG. 5 is a schematic structural diagram of still yet another stereoscopic display device shown in an embodiment of the present application;

FIG. 6 is a schematic structural diagram of a varifocal lens array in the stereoscopic display device shown in FIG. 2;

FIG. 7 is a top view of any one of electric field components in the varifocal lens array shown in FIG. 6;

FIG. 8 is a schematic structural diagram of a varifocal lens in the varifocal lens array shown in FIG. 6;

FIG. 9 is a schematic structural diagram of another varifocal lens in the varifocal lens array shown in FIG. 6;

FIG. 10 is a schematic structural diagram of yet another varifocal lens in the varifocal lens array shown in FIG. 6;

FIG. 11 is a schematic structural diagram of a varifocal lens in the stereoscopic display device shown in FIG. 2;

FIG. 12 is another schematic structural diagram of the varifocal lens shown in FIG. 11; and

FIG. 13 is a flowchart of a method for controlling a stereoscopic display device provided by an embodiment of the present application.

### DETAILED DESCRIPTION

The embodiments of the present application will be described in further detail with reference to the accompanying drawings, to make the objects and technical solutions of the present application clearer.

In the process of implementing the present application, the inventors have found that in a parallax type stereoscopic display device, the blocking of a parallax barrier enables the viewer to see only a part of a screen on a display panel through the left eye or the right eye, thereby resulting in relatively low resolution and brightness of the stereoscopic display device. That is, the resolution and brightness of each frame of image displayed by the stereoscopic display device are relatively low.

The stereoscopic display device provided by an embodiment of the present application is a device that applies a light field display technology.

The light field display technology may be considered as a technique capable of presenting images having different image distances in front of each eye of a viewer. These images having different image distances can produce a stereoscopic display effect. In addition, since the viewer sees a real image point through his/her eyes, there is no process of human eye adjustment and assembly (that is, the different images seen by both eyes are assembled into one image), such that the human eyes have no fatigue in viewing, accompanied with a better stereoscopic display effect.

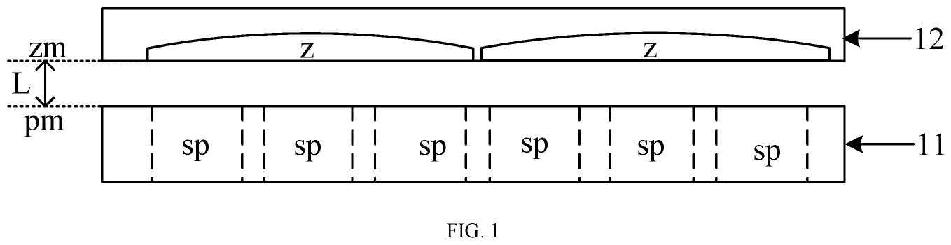

FIG. 1 is a schematic structural diagram of a stereoscopic display device shown in an embodiment of the present application. The stereoscopic display device may include a display panel 11 and a varifocal lens array 12.

The varifocal lens array 12 is disposed on a side of the display panel 11 where an image surface pm is located.

The varifocal lens array 12 includes at least two varifocal lenses z arranged in an array. Any one of the at least two varifocal lenses z corresponds to n sub-pixel regions sp on the display panel 11. The at least two varifocal lenses z are configured to be capable of making colored light of the corresponding sub-pixel regions sp form images having different image distances on a side of the varifocal lens z near the display panel 11. An orthographic projection of a sub-pixel region sp corresponding to any one of the varifocal lenses z on a lens plane zm is located in a region where said any one of the varifocal lenses z is on the lens plane zm, wherein n is a positive integer, and n sub-pixel regions sp are at least one sub-pixel region sp. FIG. 1 illustrates a case where each of the varifocal lenses z corresponds to three sub-pixel regions sp (that is, a case where n=3), but n may be other values, which is not limited in the embodiment of the present application.

Since an image displayed on the display panel may be considered to be composed of colored lights emitted by respective pixels. That is, an image of the colored lights is formed by the varifocal lens z on a side of the varifocal lens array 12 near the display panel 11. Therefore, an image surface pm of the display panel 11 may be a surface, on which colored lights are formed, of the display panel 11. The image surface pm may also be different depending on the difference in the structure (or type) of the display panel 11.

The lens plane zm is a plane where the varifocal lens array 12 is. A maximum distance L between the image plane pm of the display panel 11 and the lens plane zm is smaller than a focal length of each of the varifocal lenses z in the varifocal lens array 12. After such setting is completed, the image plane pm of the display panel 11 may form an erect virtual image on a side of the varifocal lens array 12 near the display panel 11.

In summary, according to the stereoscopic display device provided by the embodiment of the present application, the image distances of different pixel regions are changed by the varifocal lens array, such that the stereoscopic display effect is achieved without blocking the screen displayed on the display panel. The problem that the resolution and the brightness of the stereoscopic display device in the related art are relatively low is solved. The effects of higher resolution and brightness of the stereoscopic display device are achieved.

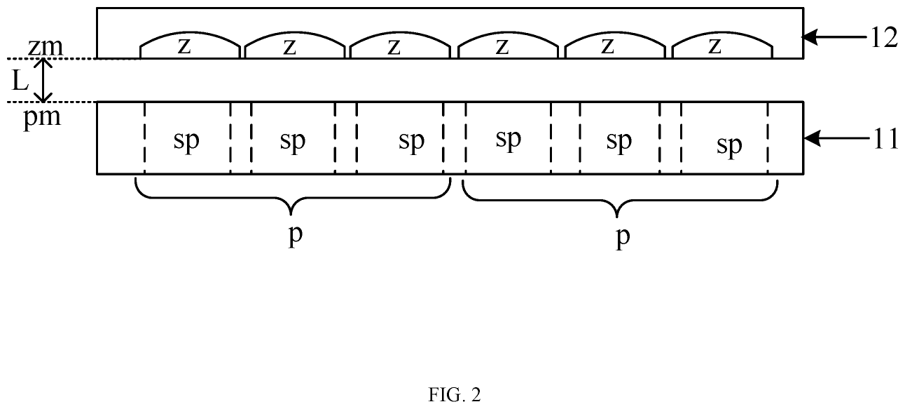

FIG. 2 illustrates a schematic structural diagram of another stereoscopic display device provided by an embodiment of the present application. The array substrate is subject to some adjustments on the basis of the stereoscopic display device shown in FIG. 1.

Optionally, any one of the plurality of varifocal lenses z corresponds to one sub-pixel region sp on the display panel 11. Thus, each sub-pixel region sp is considered as an independent light source, and each sub-pixel region sp corresponds to one varifocal lens z. That is, the plurality of sub-pixel regions sp is in one-to-one correspondence with the plurality of varifocal lenses z, and light emitted from the sub-pixel regions is controlled by the varifocal lenses in a one-to-one correspondence manner. Compared with a case where a plurality of sub-pixel regions shares one varifocal lens, the effect of improving the utilization ratio of light emitted by the display panel is achieved.

Optionally, the lens plane zm is parallel to the image surface pm on the display panel 11.

The display panel 11 includes a plurality of pixel regions p, and each of the pixel regions p includes at least one sub-pixel region sp. FIG. 2 illustrates a case where one pixel region p includes three sub-pixel regions sp, which may be sub-pixel regions for emitting red light, blue light, and green light, respectively.

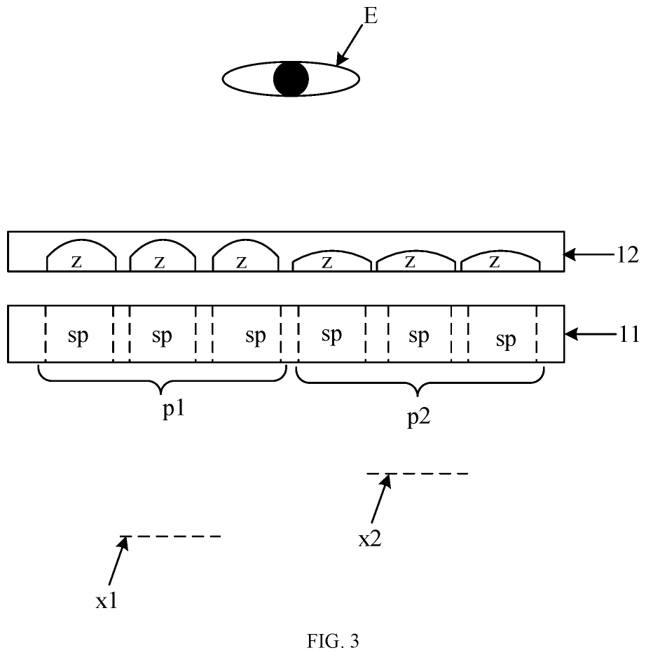

Since each pixel region is generally used for displaying one color (this color may be a color synthesized by colors displayed by a plurality of sub-pixel regions in one pixel region, for example, if three sub-pixel regions in the pixel region respectively emit red light, green light, and blue light having the same brightness, respectively, the synthesized colored light emitted by this pixel region may be white light) in the course of display, the focal length of the varifocal lens z corresponding to each of the sub-pixel regions sp in any one of the pixel regions p may be always the same when changing. FIG. 3 is a schematic diagram of a stereoscopic display device observed by the human eye E from a side of a varifocal lens array 12 away from a display panel 11. In FIG. 3, the focal lengths of the plurality of varifocal lenses z corresponding to the sub-pixel p1 are the same, and the focal lengths of the plurality of varifocal lenses z corresponding to the sub-pixel p2 are the same. However, the focal length of each of the plurality of varifocal lenses z corresponding to the sub-pixel p1 may be different from the focal length of each of the plurality of varifocal lenses z corresponding to the sub-pixel p2. As can be seen through human eyes, an image distance of an image x1 formed at the sub-pixel p1 is also different from an image distance of an image x2 formed at the sub-pixel p2.

In some embodiments, each pixel region may also include other numbers of sub-pixel regions. Exemplarily, each pixel region may further include four sub-pixel regions, which may be sub-pixel regions for emitting red light, blue light, green light, and white light, respectively.

In the stereoscopic display device provided by an embodiment of the present application, there may be a plurality of types of display panels.

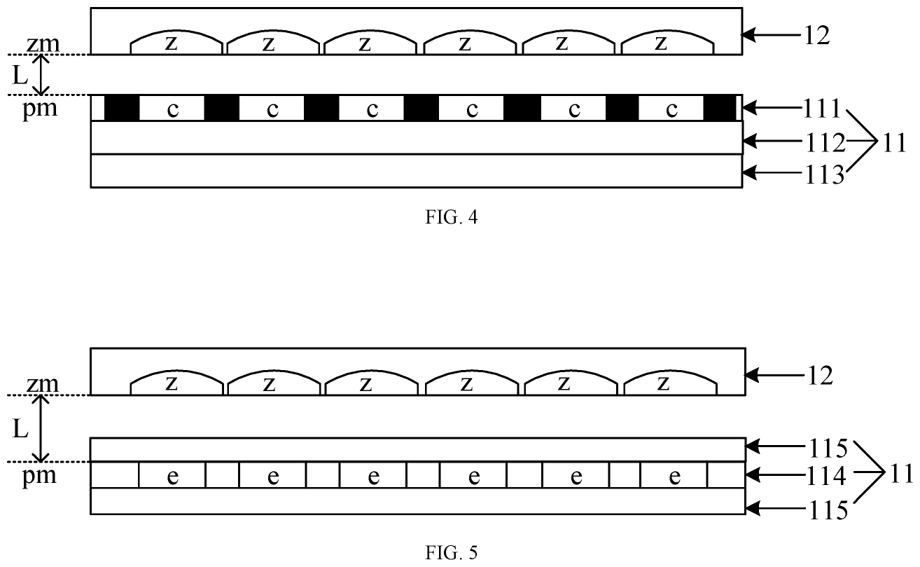

Optionally, FIG. 4 is a schematic structural diagram of yet another stereoscopic display device shown in an embodiment of the present application. In FIG. 4, a display panel 11 is a liquid crystal display (LCD) panel. The LCD panel includes a color filter substrate 11. A varifocal lens array 12 is located on a side of the color filter substrate 111. Moreover, the display panel 11 may further include a liquid crystal layer 112, an array substrate 113 and other structures, which are sequentially disposed on a side of the color filter substrate 111 away from the varifocal lens array 12.

Colored light in the LCD panel is emitted by the color filter substrate. That is, light emitted from a backlight source (the backlight source is not shown in FIG. 4, but is usually disposed on a side of the array substrate away from the liquid crystal layer) sequentially penetrates through the array substrate and the liquid crystal layer, and then illuminates the color filter substrate, and the color filter substrate will then emit colored light. Therefore, a light exiting surface of the color filter substrate 111 (this light exiting surface is a surface of the color filter substrate 111 near the varifocal lens array 12) is the image surface pm. The color filter substrate 111 may include a plurality of color blocks c (these color blocks may be color filters or quantum dot color filters, etc.), and light penetrating through the color blocks c may form colored lights of various colors. Exemplarily, when the light illuminates the blue color block, the blue color block emits blue light; and when the light illuminates the red color block, the red color block emits red light.

Optionally, FIG. 5 is a schematic structural diagram of still yet another stereoscopic display device shown in an embodiment of the present application. In FIG. 5, the display panel 11 is an organic light-emitting diode (OLED for short) display panel including a light-emitting layer 114. The light-emitting layer 114 may include light-emitting layer patterns for emitting different colored lights. Moreover, the OLED display panel may further include a driving circuit 115 for driving the light-emitting layer 114. The structure of the driving circuit 115 is merely illustrative and is not a limitation on the structure of the OLED display panel.

The colored lights are directly emitted by the light-emitting layer under the driving of the driving circuit 115 in the OLED display panel, and thus a light exiting surface of the light-emitting layer 114 (this light-emitting surface is a surface of the light-emitting layer 114 near the varifocal lens array 12) is the image surface pm.

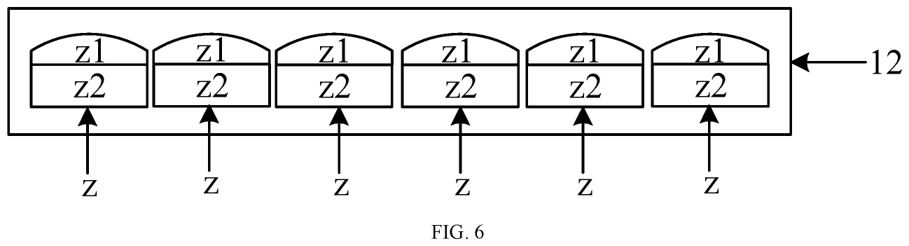

Optionally, FIG. 6 is a schematic structural diagram of a varifocal lens array in the stereoscopic display device shown in FIG. 2. In FIG. 6, each varifocal lens z is an electrostrictive lens. The electrostrictive lens is a lens made of an electrostrictive material, wherein the electrostrictive material may deform under the action of an applied electric field, thereby changing a focal length of the electrostrictive lens.

Optionally, each of the electrostrictive lenses includes a transparent electrostrictive ceramic lens z1 and an electric field component z2 disposed outside the transparent electrostrictive ceramic lens z1. The transparent electrostrictive ceramics is a material capable of undergoing telescopic deformation under the action of an electric field, and the curvature of the lens may be controlled by this characteristic (the focal length of the lens is related to the curvature of the lens, and the focal length of the lens may be changed by changing the curvature of the lens. For example, the curvature of the varifocal lens z corresponding to the sub-pixel region p1 shown in FIG. 3 is significantly different from the curvature of the varifocal lens z corresponding to the sub-pixel region p2), thereby achieving the effect of adjusting the focal length of the transparent electrostrictive ceramic lens.

Optionally, each of the varifocal lenses z in the varifocal lens array shown in FIG. 6 may also be a liquid crystal varifocal lens.

Optionally, the liquid crystal varifocal lens includes a liquid crystal lens and an electric field component disposed outside the liquid crystal lens. The liquid crystal molecules in the liquid crystal lens may be deflected under the action of an electric field generated by the electric field component, thereby changing the focal length of the liquid crystal varifocal lens.

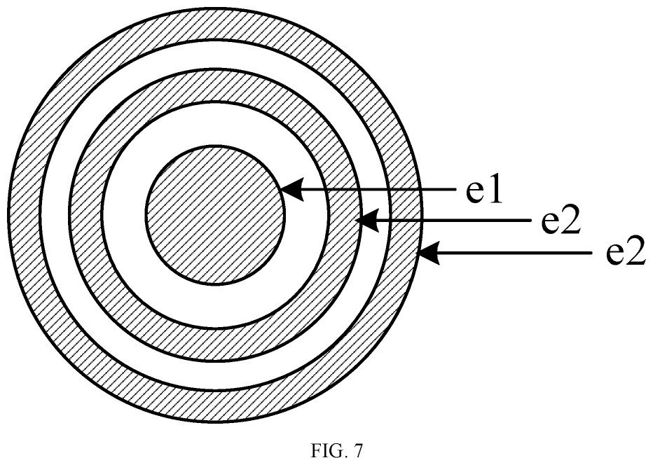

Optionally, FIG. 7 is a top view of any one of electric field components in the varifocal lens array shown in FIG. 6. This electric field component includes a circular electrode e1 and at least one annular electrode e2 disposed around the circular electrode e1 (FIG. 7 refers to a case where the number of the annular electrodes e2 is 2, but the number of the annular electrodes e2 may be other, such as 1, 3 or 5, etc., and will not be limited in the embodiment of the present application). A transverse electric field (in a direction perpendicular to the optical axis of the transparent electrostrictive ceramic lens z1 in FIG. 6) can be formed between any two adjacent electrodes (e.g., the circular electrode e1 and the annular electrode e2 adjacent to the circular electrode e1). The curvatures of different regions of the liquid crystal lens or the transparent electrostrictive ceramic lens may be controlled by the transverse electric field, and the curvature of the entire liquid crystal lens or the entire transparent electrostrictive ceramic lens may be controlled, thereby achieving the effect of adjusting the focal length of the liquid crystal lens or the transparent electrostrictive ceramic lens.

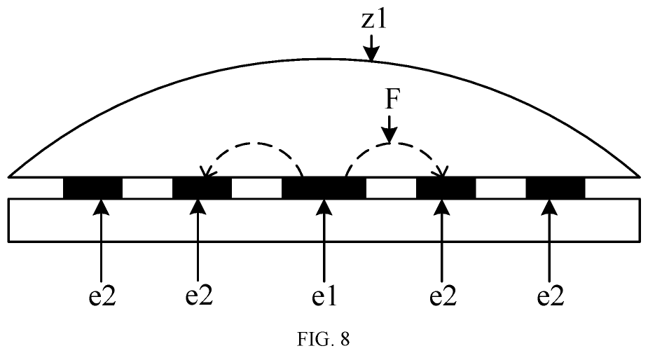

FIG. 8 is a schematic structural diagram of a varifocal lens in the varifocal lens array shown in FIG. 6. It can be seen that the circular electrode e1 and the annular electrode e2 adjacent to the circular electrode e1 constitute a transverse electric field F capable of controlling the curvatures of part of the transparent electrostrictive ceramic lenses z1.

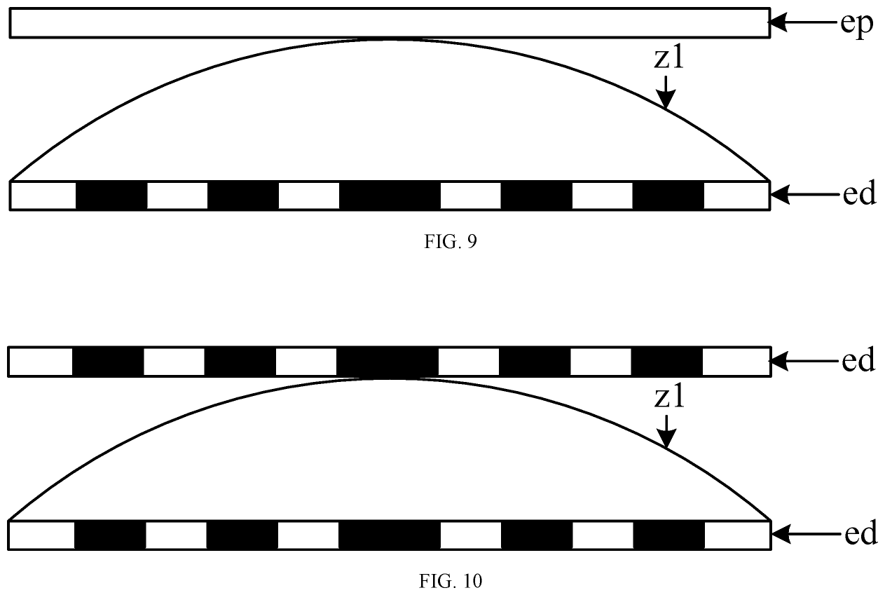

Optionally, FIG. 9 is a schematic structural diagram of another varifocal lens in the varifocal lens array shown in FIG. 6. In FIG. 9, the electric field component includes an electrode layer ep disposed on one surface of the transparent electrostrictive ceramic lens z1, and an electrode pattern ed disposed on the other surface of the transparent electrostrictive ceramic lens z1. The electrode pattern ed includes a circular electrode and at least one annular electrode disposed around the circular electrode. The structure of the electrode pattern ed may refer to the electric field component shown in FIG. 7, and will not be repeated here.

The electrode layer ep and the electrode pattern ed may constitute an electric field parallel to the optical axis of the transparent electrostrictive ceramic lens z1, and the electric field may control the curvatures of different regions of the transparent electrostrictive ceramic lens z1, thereby achieving the effect of adjusting the focal length of the transparent electrostrictive ceramic lens.

The electrostrictive ceramic lens z1 in FIG. 9 may also be replaced by a liquid crystal lens, and will not be repeated here.

Optionally, FIG. 10 is a schematic structural diagram of yet another varifocal lens in the varifocal lens array shown in FIG. 6. In FIG. 10, the electric field component includes electrode patterns ed disposed on both sides of the transparent electrostrictive ceramic lens. Each of the electrode patterns ed includes a circular electrode and at least one annular electrode disposed around the circular electrode. The structure of each of the electrode patterns ed may refer to the electric field component shown in FIG. 7, and will not be repeated here.

The electrode patterns ed located on both sides of the transparent electrostrictive ceramic lens z1 can constitute an electric field parallel to the optical axis of the transparent electrostrictive ceramic lens z1 as well, and the electric field can control the curvatures of different regions of the transparent electrostrictive ceramic lens z1, thereby achieving the effect of adjusting the focal length of the transparent electrostrictive ceramic lens.

The electrostrictive ceramic lens z1 in FIG. 10 may also be replaced by a liquid crystal lens, and will not be repeated here.

In some embodiments, each of the varifocal lenses z shown in FIG. 2 is a spherical varifocal lens or an aspherical varifocal lens. The spherical varifocal lens is simple in structure and relatively low in cost. The aspherical varifocal lens has relatively high optical performance.

Optionally, each of the varifocal lenses z shown in FIG. 2 is a liquid varifocal lens. The liquid varifocal lens typically includes a liquid lens and an component for changing a curvature of the liquid lens. The focal length of the liquid lens can be changed by changing the curvature of the liquid lens.

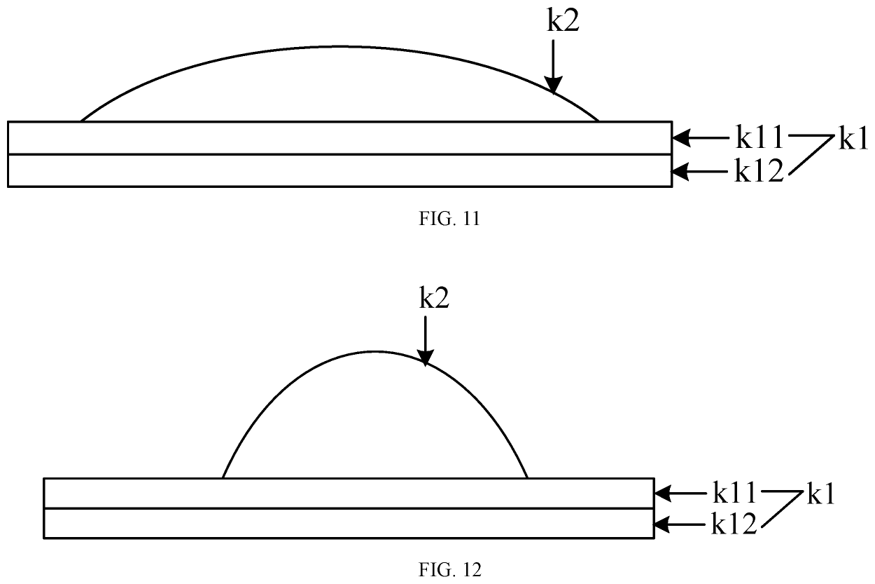

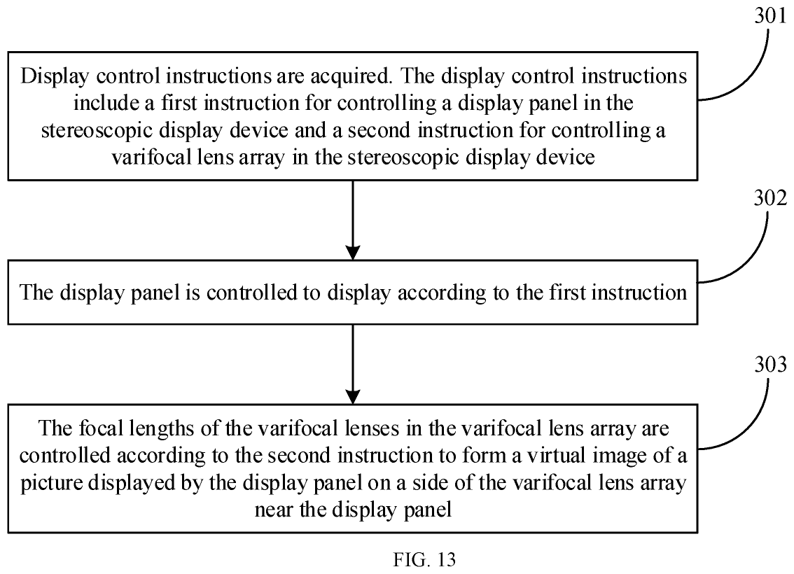

Optionally, FIG. 11 is a schematic structural diagram of a varifocal lens in the stereoscopic display device shown in FIG. 2. The varifocal lens may be a liquid varifocal lens based on electrowetting principle. Electrowetting refers to the phenomenon of changing the wettability of droplets on an insulating substrate by changing a voltage between the droplets and the substrate, i.e., changing a contact angle, to deform or displace the droplets.

The varifocal lens may include an electrowetting structure k1 (which is an component for changing the curvature of the liquid lens) and a liquid lens k2 (which may be composed of an aqueous or oily liquid). The electrowetting structure k1 includes an electrowetting layer k11 and an electric field structure k12. The electrowetting layer k11 may be hydrophilic and oleophobic, or oleophilic and hydrophobic under the control of the electric field structure k12. Exemplarily, if the liquid lens is composed of an aqueous liquid, when the curvature of the liquid lens k2 is to be reduced, the electrowetting layer k11 can be controlled by the electric field structure k12 to be hydrophilic and oleophobic. As shown in FIG. 11, the liquid lens k2 will be unfolded in the electrowetting layer k11, and the curvature of the liquid lens k2 is reduced. When the curvature of the liquid lens k2 is to be increased, the electrowetting layer k11 can be controlled by the electric field structure k12 to be lipophilic and hydrophobic. As shown in FIG. 12, the liquid lens k2 will contract on the electrowetting layer k11, and the curvature of the liquid lens k2 will be increased.

Optionally, the stereoscopic display device provided by an embodiment of the present application may further include a controller. The controller may be a control integrated circuit (IC for short) of a display panel, or may be a controller independent of the control IC of the display panel. The controller independent of the control IC of the display panel may include a central processing unit (CPU for short) or other control circuit. The controller may be used to control the control IC of the display panel, and the varifocal lens array.

Moreover, in a parallax type stereoscopic display device in related arts, a display panel will display an image presented to the left eye and an image displayed to the right eye. These two images may generate a certain amount of crosstalk, which adversely affects the display effect of the display panel. In addition, when a viewer views the parallax type stereoscopic display device, the physiological contradiction between the human eyes' adjustment and assembly brings fatigue to the human eyes. However, a stereoscopic image displayed by the stereoscopic display device provided by the embodiment of the present application is simultaneously presented to the left eye and the right eye. That is, the viewer sees a real image point through the left eye and the right eye, without causing the crosstalk. Meanwhile, the fatigue to the human eyes is also reduced, and the display effect of the stereoscopic display device is improved.

In summary, according to the stereoscopic display device provided by the embodiment of the present application, the image distances of different pixel regions are changed by the varifocal lens array, and the stereoscopic display effect is achieved without blocking the screen of the display panel. The problem that the resolution and the brightness of the stereoscopic display device in the related art are relatively low is solved. The effects of higher resolution and brightness of the stereoscopic display device are achieved.

FIG. 12 is a flowchart of a method for controlling a stereoscopic display device provided by an embodiment of the present application. This method may be used to control controllers of some of the stereoscopic display devices provided by the above embodiments. The method for controlling the stereoscopic display device may include the following steps.

In step 301, display control instructions are acquired. The display control instructions include a first instruction for controlling a display panel in the stereoscopic display device and a second instruction for controlling a varifocal lens array in the stereoscopic display device.

The display control instructions may be determined by the controller of the stereoscopic display device based on picture information to be displayed. An image to be displayed by the display panel and image distances of different regions in the image may be recorded in the picture information. The controller of the stereoscopic display device may generate display control instructions based on the information. The display control instructions include a first instruction for controlling the display panel in the stereoscopic display device and a second instruction for controlling a varifocal lens array in the stereoscopic display device (the second instruction may include focal length data of varifocal lenses in different regions in the varifocal lens array, wherein the focal length data may be generated according to image distances of different regions in the image). The controller of the stereoscopic display device may refer to the description in the above embodiments, which will not be repeated here. Exemplarily, the above stereoscopic display device may be used to display a 3-dimensional image or a 2-dimensional image. When the 3-dimensional image is displayed, the controller may control the display panel to perform normal display according to the first instruction, and set focal lengths of the varifocal lenses in different regions in the varifocal lens array according to the second instruction, such that the focal lengths of the varifocal lenses in different regions are different, thereby forming images having different image distances. When the 2-dimensional image is displayed, the controller may control the display panel to perform normal display according to the first instruction, and set the focal lengths of all the varifocal lenses in the varifocal lens array to the same value according to the second instruction, thereby forming images having the same image distances.

The screen information may be transmitted to the stereoscopic display device by an external device wiredly or wirelessly.

In step 302, the display panel is controlled to display according to the first instruction.

The controller of the stereoscopic display device may control the display panel to perform display according to the first instruction.

In step 303, the focal lengths of the varifocal lenses in the varifocal lens array are controlled according to the second instruction to form a virtual image of a picture displayed by the display panel on a side of the varifocal lens array near the display panel.

The controller of the stereoscopic display device may control the focal lengths of the varifocal lenses in the varifocal lens array according to the second instruction while performing step 302, to form a virtual image of the picture displayed by the display panel on a side of the varifocal lens array near the display panel. That is, step 303 and step 302 can be performed simultaneously.

In the course of performing this step, the controller of the stereoscopic display device may control the focal lengths of different varifocal lenses in the varifocal lens array according to the second instruction, such that the display panel forms virtual images having different image distances on a side of the varifocal lens array near the display panel. Thus, an audience located on the light exiting side of the varifocal lens array can see the virtual images having different image distances and stereoscopic display effects.

In summary, according to the method for controlling the stereoscopic display device provided by the embodiment of the present application, the image distances of different pixel regions are changed by the varifocal lens array, thereby achieving a stereoscopic display effect without blocking the screen of the display panel. The problem that the resolution and brightness of the stereoscopic display device are relatively low since a viewer can see only a part of the screen on the display panel through the left eye or the right eye because of the blocking of a parallax barrier in the related art is solved. The effects of higher resolution and brightness of the stereoscopic display device are achieved.

A apparatus for controlling a stereoscopic display device is used to control any one of the stereoscopic display devices provided by the above embodiments of the present application. The apparatus for controlling the stereoscopic display device includes one or more processor; and a memory in which one or more programs are stored and configured to be executed by the one or more processors. The one or more programs include instructions for performing the following operations: acquiring display control instructions, the display control instructions including a first instruction for controlling a display panel in the stereoscopic display device and a second instruction for controlling a varifocal lens array in the stereoscopic display device; controlling the display panel to display according to the first instruction; and setting focal lengths of varifocal lenses in the varifocal lens array according to the second instruction to form a virtual image of a picture displayed by the display panel on a side of the varifocal lens array near the display panel.

A non-transitory computer readable storage medium in which computer programs are stored is disclosed. When the computer programs are executed by the processor, any method for controlling the stereoscopic display devices provided by the above embodiments described above may be implemented.

It should be noted that, in the drawings, the sizes of layers and regions may be exaggerated for clarity of illustration. It will also be understood that when an element or layer is referred to as being “on” another element or layer, it can be directly on the other element or there may be an intermediate layer. In addition, it can be understood that when an element or layer is referred to as being “under” another element or layer, it can be directly under the element, or there may be more than one intermediate layer or element. In addition, it can also be understood that when a layer or element is referred to as being “between” two layers or two elements, it may be a single layer between two layers or two elements, or there can also be more than one intermediate layer or element. Like reference numerals throughout the whole paper refer to like elements.

In addition, the terms “first” and “second” are used for a descriptive purpose only and shall not be construed as indicating or implying relative importance. The term “a plurality of” means two or more, unless expressly limited otherwise.

The foregoing descriptions are only optional embodiments of the present application, and are not intended to limit the present application. Within the spirit and principles of the disclosure, any modifications, equivalent substitutions, improvements, etc., are within the protection scope of the present application.

What is claimed is:

1. A stereoscopic display device, comprising a display panel and a varifocal lens array, wherein
the varifocal lens array is on a side of display panel where an image surface is;
the varifocal lens array comprises at least two varifocal lenses arranged in an array, wherein any one of the varifocal lenses corresponds to at least one sub-pixel region on the display panel, and the at least two varifocal lenses are configured to be capable of making colored lights of the corresponding sub-pixel regions form images having different image distances on a side of the varifocal lenses near the display panel; wherein
the image surface of the display panel is a surface of the display panel where colored light is formed.

2. The stereoscopic display device according to claim 1, wherein each varifocal lens corresponds to one sub-pixel region on the display panel.

3. The stereoscopic display device according to claim 1,
wherein an orthographic projection of a sub-pixel region corresponding to any one of the at least two varifocal lenses on a lens plane is in a region where said any one of the at least two varifocal lenses is on the lens plane, and the lens plane is a plane where the varifocal lens array is.

4. The stereoscopic display device according to claim 3, wherein the lens plane is parallel to the image surface of the display panel.

5. The stereoscopic display device according to claim 1, wherein the display panel is a liquid crystal display panel comprising a color filter substrate, wherein
a surface of the color filter substrate near the varifocal lens array is the image surface.

6. The stereoscopic display device according to claim 1, wherein the display panel is an organic light-emitting diode display panel comprising a light-emitting layer, wherein
a surface of the light-emitting layer near the varifocal lens array is the image surface.

7. The stereoscopic display device according to claim 1, wherein each of the varifocal lenses is an electrostrictive lens.

8. The stereoscopic display device according to claim 7, wherein the electrostrictive lens comprises a transparent electrostrictive ceramic lens and an electric field component outside the transparent electrostrictive ceramic lens.

9. The stereoscopic display device according to claim 1, wherein each of the varifocal lenses is a liquid varifocal lens.

10. The stereoscopic display device according to claim 9, wherein the liquid varifocal lens is a liquid varifocal lens based on electrowetting principle.

11. The stereoscopic display device according to claim 1, wherein each of the varifocal lenses is a liquid crystal varifocal lens.

12. The stereoscopic display device according to claim 11, wherein the liquid crystal varifocal lens comprises a liquid crystal lens and an electric field component outside the liquid crystal lens.

13. The stereoscopic display device according to claim 8, wherein the electric field component is any one of the following structures:
a structure comprising a circular electrode and at least one annular electrode around the circular electrode;
a structure comprising an electrode layer on one surface of the transparent electrostrictive ceramic lens, and an electrode pattern on the other surface of the transparent electrostrictive ceramic lens, wherein the electrode pattern comprises a circular electrode and at least one annular electrode around the circular electrode; and
a structure comprising electrode patterns on both sides of the transparent electrostrictive ceramic lens, wherein each of the electrode patterns comprises a circular electrode and at least one annular electrode around the circular electrode.

14-15. (canceled)

16. The stereoscopic display device according to claim 1, wherein each of the varifocal lenses is a spherical varifocal lens or an aspherical varifocal lens.

17. A method for controlling a stereoscopic display device, wherein the stereoscopic display device comprises a display panel and a varifocal lens array, wherein the varifocal lens array is on a side of display panel where an image surface is; the varifocal lens array comprises at least two varifocal lenses arranged in an array, wherein any one of the varifocal lenses corresponds to at least one sub-pixel region on the display panel, and the at least two varifocal lenses are configured to be capable of making colored lights of the corresponding sub-pixel regions form images having different image distances on a side of the varifocal lenses near the display panel; wherein the image surface of the display panel is a surface of the display panel where colored light is formed; and the method comprises:
acquiring display control instructions, the display control instructions comprising a first instruction for controlling a display panel in the stereoscopic display device and a second instruction for controlling a varifocal lens array in the stereoscopic display device;
controlling the display panel to display according to the first instruction; and
setting focal lengths of varifocal lenses in the varifocal lens array according to the second instruction to form a virtual image of a picture displayed by the display panel on a side of the varifocal lens array near the display panel.

18. The method according to claim 17, wherein setting focal lengths of varifocal lenses in the varifocal lens array according to the second instruction to form a virtual image of a picture displayed by the display panel on a side of the varifocal lens array near the display panel comprises:
controlling, according to the second instruction, focal lengths of different varifocal lenses in the varifocal lens array, such that the display panel forms virtual images having different image distances on a side of the varifocal lens array near the display panel.

19. The stereoscopic display device according to claim 12, wherein the electric field component is any one of the following structures:
a structure comprising a circular electrode and at least one annular electrode around the circular electrode;
a structure comprising an electrode layer on one surface of the transparent electrostrictive ceramic lens, and an electrode pattern on the other surface of the transparent electrostrictive ceramic lens, wherein the electrode pattern comprises a circular electrode and at least one annular electrode around the circular electrode; and
a structure comprising electrode patterns on both sides of the transparent electrostrictive ceramic lens, wherein each of the electrode patterns comprises a circular electrode and at least one annular electrode around the circular electrode.

20. An apparatus for controlling a stereoscopic display device, wherein the stereoscopic display device comprises a display panel and a varifocal lens array, wherein the varifocal lens array is on a side of display panel where an image surface is; the varifocal lens array comprises at least two varifocal lenses arranged in an array, wherein any one of the varifocal lenses corresponds to at least one sub-pixel region on the display panel, and the at least two varifocal lenses are configured to be capable of making colored lights of the corresponding sub-pixel regions form images having different image distances on a side of the varifocal lenses near the display panel; wherein the image surface of the display panel is a surface of the display panel where colored light is formed; and the apparatus comprises:
one or more processor; and
a memory; wherein
one or more programs are stored in the memory, the one or more programs are configured to be executed by the one or more processors, and the one or more programs comprise instructions for implementing:
acquiring display control instructions, the display control instructions comprising a first instruction for controlling a display panel in the stereoscopic display device and a second instruction for controlling a varifocal lens array in the stereoscopic display device;
controlling the display panel to display according to the first instruction; and
setting focal lengths of varifocal lenses in the varifocal lens array according to the second instruction to form a virtual image of a picture displayed by the display panel on a side of the varifocal lens array near the display panel.

21. The apparatus according to claim 20, wherein the one or more programs further comprise instructions for implementing:
controlling, according to the second instruction, focal lengths of different varifocal lenses in the varifocal lens array, such that the display panel forms virtual images having different image distances on a side of the varifocal lens array near the display panel.

22. A non-transitory computer readable storage medium in which computer programs are stored, wherein the computer programs implement the method for controlling a stereoscopic display device according to claim 17 when executed by a processor.
